(19) United States
(12) Patent Application Publication
(10) Pub. No.: US 2011/0043097 A1
(43) Pub. Date: Feb. 24, 2011

(54) Field emission lamp

(75) Inventors: Wen-Hsien Cheng, Taipei (TW); Tzung-Han Yang, Taipei (TW); Yung-Chih Yu, Taipei (TW); Ching-Hsuang Cheng, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/654,013

(22) Filed: Dec. 8, 2009

(30) Foreign Application Priority Data
Aug. 21, 2009 (TW) 098128186

(51) Int. Cl. H01J 1/62

(52) U.S. Cl. 313/496

(57) ABSTRACT

A field emission lamp, capable of preventing the degradation and the non-uniformly distribution of the light intensity of the emitted light, even after long-term usage of the field emission lamp, is disclosed. The anode of the disclosed field emission lamp is not required to be transparent. The disclosed field emission lamp comprises: a transparent shell; an anode unit set inside the transparent shell; a cathode unit set between the anode unit and the transparent shell; and a phosphor layer set above the anode unit. The cathode unit is apart from the phosphor layer with a certain distance. The phosphor layer and the anode unit are both surrounded by the cathode unit.

### BACKGROUND OF THE INVENTION

1. Field of the Invention

The present invention relates to a field emission lamp and, more particular, to a field emission lamp enabling long-term usage without brightness degradation and/or unfavorable light uniformity and enabling the anode to be made of a conductive material without high transparency.

2. Description of Related Art

Reference with FIG. 1, a conventional field emission lamp comprises: a transparent shell 11, an anode unit 12, a cathode unit 13, and a phosphor layer 14, in which, the transparent shell 11 has an inner surface 111, and the anode unit 12 is set on a part of the inner surface 111 of the transparent shell 11. The cathode unit 13 is fixed at the central part of the transparent shell 11 and is surrounded by the anode unit 12. The phosphor layer 14 is set on the anode unit 12.

The cathode unit 13 is apart from the phosphor layer 14 with a certain distance, the anode unit 12 and the cathode unit 13 each electrically connects to contact pins (not shown) and forms a loop with an outer driving circuit (not shown), and therefore the field emission lamp can be driven to provide light by receiving a driving voltage from the outer driving circuit.

The transparent shell 11 is a transparent tube made of soda-lime glass. Besides, the anode unit 12 is made of ITO (indium-tin oxide) or carbon-nanotube film, and the cathode unit 13 is a metal bar covered with carbon-nanotubes serving as the electron emitter.

However, a large quantity of electrons may accumulate in the phosphor layer 14 after a long-term operation (with many electrons bombarding the phosphor layer 14) of the field emission lamp, and a coulomb aging effect of the phosphor layer 14 may happen and cause brightness degradation and unsatisfactory uniformity of the light transmitted by the field emission lamp. Reference with FIG. 1, since the light provided by the phosphor layer 14 passes through the anode unit 12 set in the inner surface 111 of the transparent shell 11, a certain transparency of the anode unit 12 is needed to ensure the luminous efficacy of the field emission lamp. However, complex steps are required for the forming of the transparent electrode compared with the forming of a metal electrode, and the electrical conductivity of the produced transparent electrode is usually lower than a metal electrode, therefore the lifetime of the applied field emission lamp will be negatively influenced.

Therefore, it is desirable to provide an improved field emission lamp enabling long-term usage without brightness degradation and/or unfavorable light uniformity and enabling the anode to be made of a conductive material without high transparency.

### SUMMARY OF THE INVENTION

An object of the present invention is to provide a field emission lamp enabling long-term usage without brightness degradation and/or unfavorable light uniformity.

Another object of the present invention is to provide a field emission lamp enabling the anode to be made of a conductive material without high transparency.

Therefore, the present invention provides a field emission lamp comprising: a transparent shell; an anode unit set inside the transparent shell; a cathode unit set between the anode unit and the transparent shell; and a phosphor layer set above the anode unit, wherein the cathode unit is apart from the phosphor layer with a certain distance, and the cathode unit surrounds the anode unit.

The present invention also provides a field emission lamp comprising: a first substrate; a second substrate; an anode unit locating between the first substrate and the second substrate, wherein the anode unit is set on part of the surface of the first substrate; a phosphor layer locates between the second substrate and the anode unit, wherein the phosphor layer is set on the anode unit; and a cathode unit locates between the second substrate and the phosphor layer, wherein the cathode unit is apart from the phosphor layer with a certain distance.

According to the present invention, even with a long-term operation of the field emission lamp, the electrons accumulated in the phosphor layer can be drained efficiently by the anode unit surrounded by the phosphor layer. Therefore, the coulomb aging effect incurred in the field emission lamp of the prior arts can be resolved, and the brightness and the uniformity of the light transmitted by the field emission lamp can be increased. Also, since the anode unit of the field emission lamp of the present example locates in the central part of the field emission lamp (as shown in FIGS. 2, 3, and 4) or locates in a side of the field emission lamp (on the surface of the first substrate as shown in FIG. 5), light emitted from the phosphor layer can be transmitted by the field emission lamp without passing through the anode unit whereby the anode unit can be made of a conductive material without high transparency, the manufacturing cost can be reduced, and the process steps of the field emission lamp can be simplified.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a conventional field emission lamp;

FIG. 2 is a schematic view of a field emission lamp of example 1 of the present invention;

FIG. 3 is a schematic view of a field emission lamp of example 2 of the present invention;

FIG. 4 is a schematic view of a field emission lamp of example 3 of the present invention;

FIG. 5A is a schematic view of a field emission lamp of example 4 of the present invention;

FIG. 5B is a top view of a cathode unit comprising a cathode and an electron-emitting source of the example 4;

FIG. 6 is a top view of a cathode unit comprising a cathode and an electron-emitting source of the example 5; and

FIG. 7 is a top view of a cathode unit comprising a cathode and an electron-emitting source of the example 6.

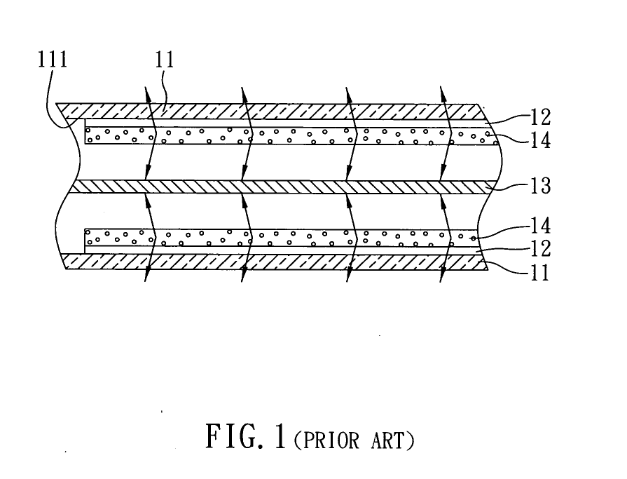

### DETAILED DESCRIPTION OF THE PREFERRED EMBODIMENT

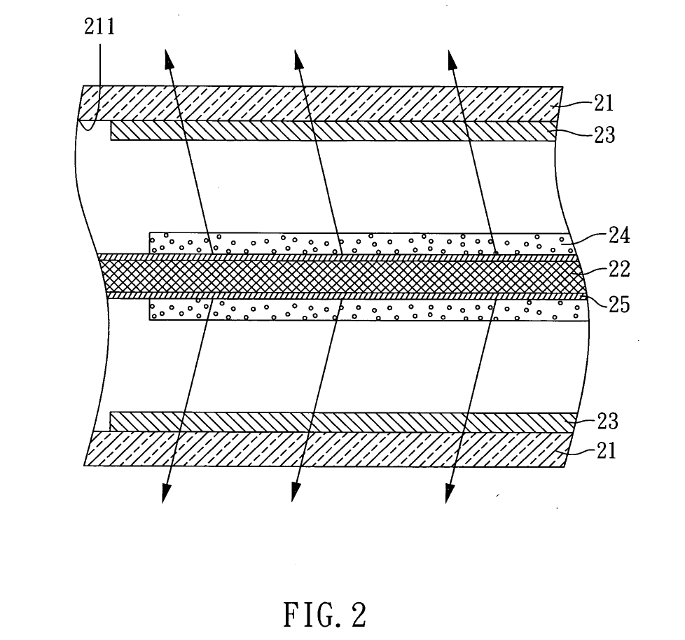

Reference with FIG. 2, the field emission lamp of the present example 1 comprises: a transparent shell 21, an anode unit 22, a cathode unit 23, and a phosphor layer 24. The anode unit 22 is set inside the transparent shell 21, the cathode unit 23 is set between the anode unit 22 and the transparent shell 21, the cathode unit 23 is apart from the phosphor layer 24 with a certain distance, and the cathode unit 23 surrounds the anode unit 22 and the phosphor layer 24.

In the present example, the cathode unit 23 is set on an inner surface 211 of the transparent shell 21 as shown in FIG. 2. The anode unit 22 and the cathode unit 23 each electrically connects to contact pins (not shown) and forms a loop with an outer driving circuit (not shown), and therefore the field emission lamp can be driven to provide light by receiving a driving voltage from the outer driving circuit.

In the present example, the transparent shell 21 is a transparent tube and is made of soda lime glass. However, the transparent shell 21 may also be made of soda glass, boron glass, lead glass, quartz glass, or alkali-free glass. The cathode unit 23 is an ITO (indium-tin oxide) layer having carbon nanotubes mixed therein, but the cathode unit 23 may also be an IMO (indium molybdenum oxide) layer, an IZO (indium-zinc oxide) layer, or a graphite thin film having carbon nanotubes mixed therein. The anode unit 22 is made of metal such as stainless steel, aluminum alloy, or nickel alloy.

In the present example, a reflective layer 25 locating between the phosphor layer 24 and the anode unit 22 is further provided to increase the luminous efficacy of the field emission lamp, in which the reflective layer 25 is an aluminum foil. Herein, the reflective layer 25 may also be other metal foil having high reflectivity such as a gold foil, a silver foil, or a tin foil.

Hence, even after long-term operation (with many electrons emitted from the cathode unit 23 bombarding the phosphor layer 24) of the field emission lamp, the electrons accumulated in the phosphor layer 24 can be drained efficiently by the anode unit 22 surrounded by the phosphor layer 24. Therefore, the coulomb aging effect incurred in the field emission lamp of the prior arts can be resolved, and the brightness and the uniformity of the light provided by the field emission lamp can be increased.

Reference with FIG. 2, since the anode unit 22 of the field emission lamp of the present example locates in the central part of the field emission lamp, light emitted from the phosphor layer 24 can be transmitted from the field emission lamp without passing through the anode unit 22 whereas the anode unit 22 can be made of a conductive material without high transparency, the manufacturing cost can be reduced, and the process steps of the field emission lamp can be simplified.

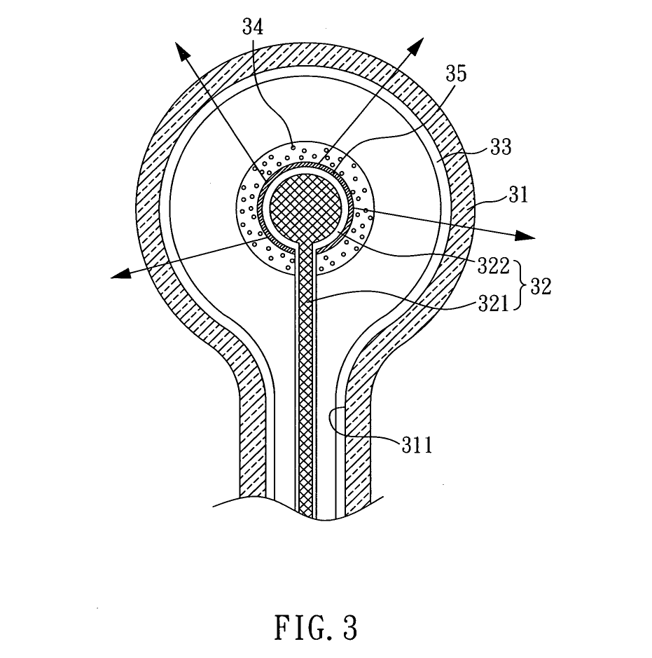

Reference with FIG. 3, the field emission lamp of the present example 2 comprises a transparent shell 31, an anode unit 32, a cathode unit 33, and a phosphor layer 34. The anode unit 32 is set inside the transparent shell 31, the cathode unit 33 is set between the anode unit 32 and the transparent shell 31, the cathode unit 33 is apart from the phosphor layer 34 with a certain distance, and the cathode unit 33 surrounds the anode unit 32 and the phosphor layer 34.

According to the present example, the cathode unit 33 is set on an inner surface 311 of the transparent shell 31 as shown in FIG. 3. The anode unit 32 and the cathode unit 33 each electrically connects to contact pins (not shown) and forms a loop with an outer driving circuit (not shown), and therefore the field emission lamp can be driven to provide light by receiving a driving voltage from the outer driving circuit.

In the present example, the transparent shell 31 is formed in a hollow bulb shape and is made of soda-lime glass. However, the transparent shell 31 may also be made of soda glass, boron glass, lead glass, quartz glass, or alkali-free glass. The cathode unit 33 is an ITO (indium-tin oxide) layer having carbon nanotubes mixed therein, but the cathode unit 23 may also be an IMO (indium molybdenum oxide) layer, an IZO (indium-zinc oxide) layer, or a graphite thin film having carbon nanotubes mixed therein.

The anode unit 32 comprises a glass rod 321 and an electrical conductive layer 322 coated on the glass rod 321. In the present example 2, a reflective layer 35 locating between the phosphor layer 34 and the anode unit 32 is further provided to increase the luminous efficacy of the field emission lamp, in which the reflective layer 35 is an aluminum foil. Herein, the reflective layer 35 may also be another metal foil having high reflectivity such as a gold foil, a silver foil, or a tin foil.

Hence, even after long-term operation (with many electrons emitted from the cathode unit 33 bombarding the phosphor layer 34) of the field emission lamp, the electrons accumulated in the phosphor layer 34 can be drained efficiently by the anode unit 32 surrounded by the phosphor layer 34. Therefore, the coulomb aging effect incurred in the field emission lamp of the prior arts can be resolved, and the brightness and the uniformity of the light provided by the field emission lamp can be increased.

Reference with FIG. 3, since the anode unit 32 of the field emission lamp of the present example 2 locates in the central part of the field emission lamp, light emitted from the phosphor layer 34 can be transmitted from the field emission lamp without passing through the anode unit 32 whereby the anode unit 32 can be made of a conductive material without high transparency, the manufacturing cost can be reduced, and the process steps of the field emission lamp can be simplified.

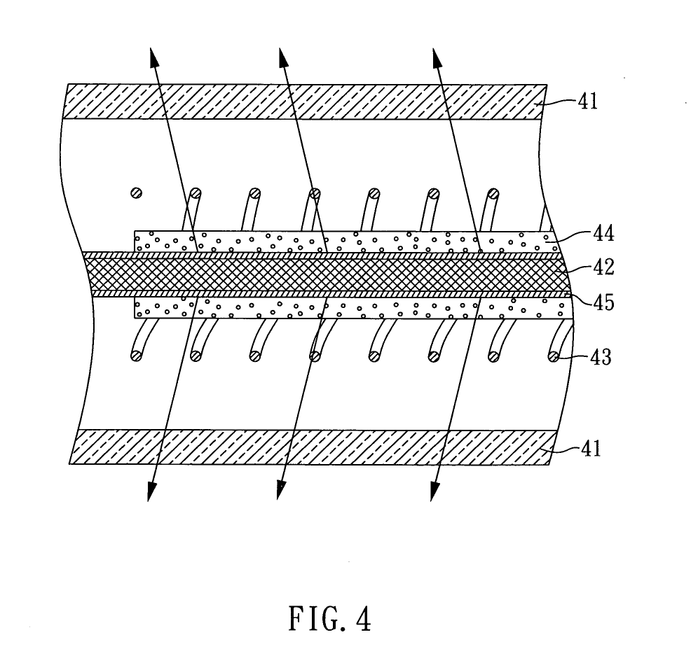

Reference with FIG. 4, the field emission lamp of the present example 3 comprises a transparent shell 41, an anode unit 42, a cathode unit 43, and a phosphor layer 44. The anode unit 42 is set inside the transparent shell 41, the cathode unit 43 is set between the anode unit 42 and the transparent shell 41, the cathode unit 43 is apart from the phosphor layer 44 with a certain distance, and the cathode unit 43 surrounds the anode unit 42 and the phosphor layer 44.

In the present example, the transparent shell 31 is formed in a helix form and surrounds the phosphor layer 44 and the anode unit 42 as shown in FIG. 4. The anode unit 42 and the cathode unit 43 each electrically connects to contact pins (not shown) and forms a loop with an outer driving circuit (not shown), and therefore the field emission lamp can be driven to provide light by receiving a driving voltage from the outer driving circuit.

In the present example, the transparent shell 41 is a transparent tube and is made of soda lime glass. However, the transparent shell 41 may also be made of soda glass, boron glass, lead glass, quartz glass, or alkali-free glass. The cathode unit 43 is a metal bar covered with the electron emitter, wherein the electron emitter is preferably carbon-nanotubes and the metal bar is preferably made of stainless steel, aluminum, or nickel. The anode unit 42 is preferably made of metal such as stainless steel, aluminum alloy, or nickel alloy.

In the present example 3, a reflective layer 45 locating between the phosphor layer 44 and the anode unit 42 is further included to increase the luminous efficacy of the field emission lamp, in which the reflective layer 45 is an aluminum foil. Herein, the reflective layer 45 may also be another metal foil having high reflectivity such as a gold foil, a silver foil, or a tin foil.

Hence, even after long-term operation (with many electrons emitted from the cathode unit 43 bombarding the phosphor layer 44) of the field emission lamp, the electrons accumulated in the phosphor layer 44 can be drained efficiently by the anode unit 42 surrounded by the phosphor layer 44. Therefore, the coulomb aging effect incurred in the field emission lamp of the prior arts can be resolved, and the brightness and the uniformity of the light transmitted from the field emission lamp can be increased.

Reference with FIG. 4, since the anode unit 42 of the field emission lamp of the present example 3 locates in the central part of the field emission lamp, light emitted from the phosphor layer 44 can be transmitted from the field emission lamp without passing through the anode unit 42 whereby the anode unit 42 can be made of a conductive material without high transparency, the manufacturing cost can be reduced, and the process steps of the field emission lamp can be simplified.

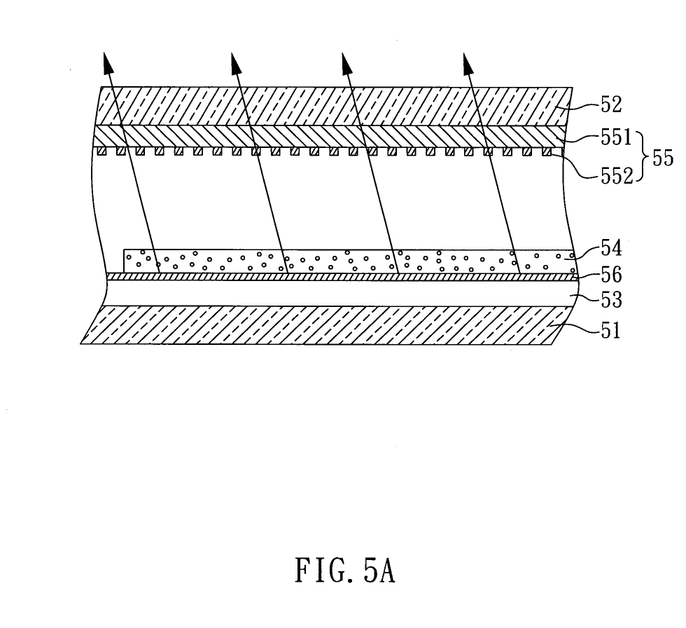

Reference with FIG. 5A, the field emission lamp of the present example 4 comprises a first substrate 51, a second substrate 52, an anode unit 53, a phosphor layer 54, and a cathode unit 55. The anode unit 53 locates between the first substrate 51 and the second substrate 52, and the anode unit 53 is set on part of the surface of the first substrate 52. The phosphor layer 54 locates between the second substrate 52 and the anode unit 53, and the phosphor layer 54 is set on the anode unit 53. The cathode unit 55 comprising a cathode 551 and an electron-emitting source 552 locates between the second substrate 52 and the phosphor layer 54, and the cathode unit 55 is apart from the phosphor layer 54 with a certain distance.

In the present example, the first substrate 51 and the second substrate 52 are each a glass sheet made of soda-lime glass, however, the first substrate 51 and the second substrate 52 can also be made of soda glass, boron glass, lead glass, quartz glass, or alkali-free glass, which is not specially limited. The anode unit 53 is made of metal such as silver or aluminum. The cathode 551 is made of ITO (indium-tin oxide), and the electron-emitting source 552 may be a patterned carbon-nanotube film.

Reference with FIG. 5B, a top view of a cathode unit comprising a cathode 551 and an electron-emitting source 552 of the present example is shown, in which the electron-emitting source 552 locating on the cathode 551 is formed in a multi-bar shape and is randomly distributed over the whole surface of the cathode 551. Alternatively, the multi-bar shaped electron-emitting source 552 can be distributed on only parts of the surface of the cathode 551 if required.

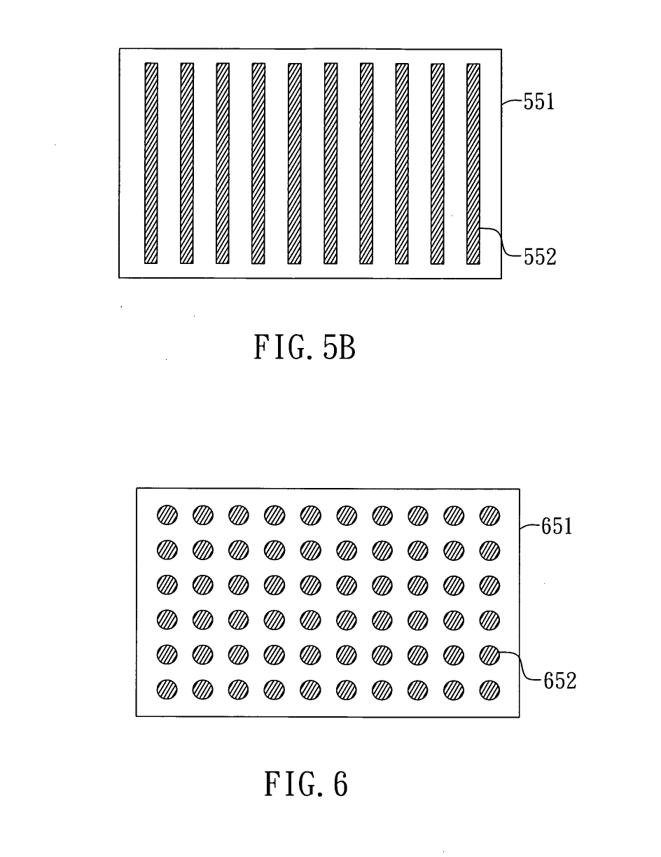

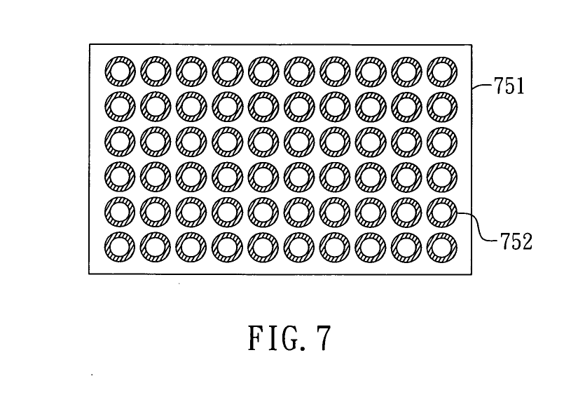

Besides, in other examples, the patterned electron-emitting source may have other patterns such as a pattern with spots or a pattern with rings, as shown in FIGS. 6 and 7 respectively, in which FIG. 6 shows an electron-emitting source of the example 5 of the present invention and FIG. 7 shows an electron-emitting source of the example 6 of the present invention. According to FIG. 6, the electron-emitting source 652 has a pattern with spots that are randomly distributed over the whole surface of the cathode 651. According to FIG. 7, the electron-emitting source 752 has a pattern with rings distributing over the whole surface of the cathode 751.

Herein, an adequate aperture ratio of the pattern of the electron-emitting source should be considered. For example, when the total surface area of the patterned electron-emitting source increases (i.e. the aperture ratio of the patterned electron-emitting source decreases), the amount of the electrons emitted from the electron-emitting source is increased and therefore the brightness can be increased. However, light emitted from the cathode may be largely shielded by the electron-emitting source while the total surface area of the patterned electron-emitting source increases. Therefore, the adequate aperture ratio of the patterned electron-emitting source should be carefully considered.

Reference with FIG. 5A, the anode unit 53 and the cathode unit 55 each electrically connects to contact pins (not shown) and forms a loop with an outer driving circuit (not shown), and therefore the field emission lamp can be driven to provide light by receiving a driving voltage from the outer driving circuit. In order to enhance luminous efficacy, a reflective layer 56 locating between the phosphor layer 54 and the anode unit 53 may be further provided in the present example 4, in which the reflective layer 56 may be an aluminum foil. Alternatively, the reflective layer 56 may also be another metal foil having high reflectivity such as a gold foil, a silver foil, or a tin foil.

Hence, even after long-term operation (with many electrons emitted from the cathode unit 55 bombarding the phosphor layer 54) of the field emission lamp, the electrons accumulated in the phosphor layer 54 can be drained efficiently by the anode unit 53 surrounded by the phosphor layer 54. Therefore, the coulomb aging effect incurred in the field emission lamp of the prior arts can be resolved, and the brightness and the uniformity of the light transmitted by the field emission lamp can be increased. Besides, reference with FIG. 5A, since the anode unit 53 of the field emission lamp of the present example 4 locates in a side of the field emission lamp (on the surface of the first substrate 51), light emitted from the phosphor layer 54 can be transmitted from the field emission lamp without passing through the anode unit 53 whereby the anode unit 53 can be made of a conductive material without high transparency, the manufacturing cost can be reduced, and the process steps of the field emission lamp can be simplified.

According to the present invention, even after long-term operation of the field emission lamp, the electrons accumulated in the phosphor layer can be drained efficiently by the anode unit surrounded by the phosphor layer. Therefore, the coulomb aging effect incurred in the field emission lamp of the prior arts can be resolved, and the brightness and the uniformity of the light transmitted from the field emission lamp can be increased. Also, since the anode unit of the field emission lamp of the present example locates in the central part of the field emission lamp (as shown in FIGS. 2, 3, and 4) or locates in a side of the field emission lamp (on the surface of the first substrate as shown in FIG. 5), light emitted from the phosphor layer can be transmitted from the field emission lamp without passing through the anode unit whereby the anode unit can be made of a conductive material without high transparency, the manufacturing cost can be reduced, and the process steps of the field emission lamp can be simplified.

Although the present invention has been explained in relation to its preferred embodiment, it is to be understood that many other possible modifications and variations can be made without departing from the scope of the invention as hereinafter claimed.

What is claimed is:

1. A field emission lamp, comprising:
a transparent shell;
an anode unit set inside the transparent shell;
a cathode unit set between the anode unit and the transparent shell; and
a phosphor layer set above the anode unit,
wherein the cathode unit is apart from the phosphor layer, and the cathode unit surrounds the anode unit.

2. The field emission lamp as claimed in claim 1, wherein the cathode unit is set on an inner surface of the transparent shell.

3. The field emission lamp as claimed in claim 1, wherein the transparent shell is made of soda lime glass, soda glass, boron glass, lead glass, quartz glass, or alkali-free glass.

4. The field emission lamp as claimed in claim 1, wherein the cathode unit is in a helix form and surrounds the phosphor layer and the anode unit.

5. The field emission lamp as claimed in claim 1, wherein the cathode unit is a transparent electrical conductive layer having carbon nanotubes mixed therein.

6. The field emission lamp as claimed in claim 5, wherein the transparent electrical conductive layer is an IMO (indium molybdenum oxide) layer, an IZO (indium-zinc oxide) layer, or a graphite thin film.

7. The field emission lamp as claimed in claim 1, wherein the anode unit is made of metal.

8. The field emission lamp as claimed in claim 1, wherein the anode unit is a glass rod coated with an electrical conductive layer.

9. The field emission lamp as claimed in claim 1, further comprising a reflective layer locating between the phosphor layer and the anode unit.

10. The field emission lamp as claimed in claim 9, wherein the reflective layer is made of aluminum, gold, silver, or tin.

11. The field emission lamp as claimed in claim 1, wherein the transparent shell is a transparent tube.

12. The field emission lamp as claimed in claim 1, wherein the transparent shell is formed in a hollow bulb shape.

13. A field emission lamp, comprising:
a first substrate;
a second substrate;
an anode unit locating between the first substrate and the second substrate, wherein the anode unit is set on part of the surface of the first substrate;
a phosphor layer locating between the second substrate and the anode unit, wherein the phosphor layer is set on the anode unit; and
a cathode unit locating between the second substrate and the phosphor layer, wherein the cathode unit is apart from the phosphor layer.

14. The field emission lamp as claimed in claim 13, wherein the cathode unit is set on a part of the surface of the second substrate.

15. The field emission lamp as claimed in claim 13, wherein the cathode unit comprises a cathode and an electron-emitting source locating on a part of the surface of the cathode unit.

16. The field emission lamp as claimed in claim 15, wherein the electron-emitting source is a patterned carbon-nanotube film, and the patterned carbon-nanotube film has a pattern with spots, a pattern with bars, or a pattern with rings.

17. The field emission lamp as claimed in claim 13, wherein the first substrate and the second substrate are independently made of soda lime glass, soda glass, boron glass, lead glass, quartz glass, or alkali-free glass.

18. The field emission lamp as claimed in claim 13, wherein the cathode unit is a transparent electrical conductive layer having carbon nanotubes mixed therein.

19. The field emission lamp as claimed in claim 18, wherein the transparent electrical conductive layer is an IMO (indium molybdenum oxide) layer, an IZO (indium-zinc oxide) layer, or a graphite thin film.

20. The field emission lamp as claimed in claim 13, wherein the anode unit is made of metal.

21. The field emission lamp as claimed in claim 13, further comprising a reflective layer locating between the phosphor layer and the anode unit.

22. The field emission lamp as claimed in claim 21, wherein the reflective layer is made of aluminum, gold, silver, or tin.
